(19) United States
(12) Patent Application Publication
(10) Pub. No.: US 2009/0049474 A1
(43) Pub. Date: Feb. 19, 2009

(54) METHOD OF PROVIDING ELECTRONIC PROGRAM GUIDE

(75) Inventor: Park Jinseok, Gyeonggi-do (KR)

Correspondence Address: OCCHIUTI ROHLICEK & TSAO, LLP, 10 FAWCETT STREET, CAMBRIDGE, MA, 02138, US

(73) Assignee: Daewoo Electronics Corporation, Seoul (KR)

(21) Appl. No.: 12/189,354

(22) Filed: Aug. 11, 2008

(30) Foreign Application Priority Data
Aug. 13, 2007 (KR) 10-2007-0081458

(51) Int. Cl. H04N 5/445

(52) U.S. Cl. 725/43; 725/40

(57) ABSTRACT

A method of providing an electronic program guide is disclosed. The method includes storing information of electronic program guides, displaying an electronic program guide of a channel output on a primary screen in response to a signal of outputting the information of the electronic program guides, and displaying an electronic program guide of a new channel output on the primary screen when the channel of the primary screen is changed to the new channel.

### BACKGROUND OF THE INVENTION

1. Field of the Invention

The present invention relates to a method of providing an electronic program guide, and more particularly to a method of providing an electronic program guide such that program organization information can be supplied along with text information or video information relating to the program organization information to provide more sufficient program information to the user.

2. Description of the Related Art

Generally, users search and refer to broadcast programs on a program guide supplied from the newspaper or the World Wide Web before watching TV broadcasts.

In recent years, however, analog televisions or digital televisions have been developed to provide a service for displaying an electronic program guide (EPG) of broadcast programs sent from broadcasting stations or secondary broadcasting service centers.

When referring to the EPG while watching a television program, a viewer often searches for a desired type of program or a program to be reserved.

Since the EPG conventionally supplies information on a number of channels for each time via a single TV screen, the viewer must pay attention to the EPG confusingly displayed on the TV screen to obtain information of a desired channel in practice, and such a confusingly displayed EPG provides inconvenience to the viewer by disturbing the viewer in watching the TV program which is currently broadcast on the screen.

Further, while changing channels on the screen, the viewer usually wants to watch the EPGs relating to the changed channels. However, a conventional method of providing the EPG fails to satisfy such a user's need. Therefore, there is a need for an improved method of providing the EPG, which overcomes the problem of the conventional method.

### SUMMARY OF THE INVENTION

The present invention is conceived to solve the problems of the conventional techniques as described above, and it is an aspect of the present invention to provide a method of providing an electronic program guide, which can display not only an electronic program guide of a channel currently watched by a viewer, but also selectively display an electronic program guide of a changed channel on a secondary screen, when the viewer changes the current channel displayed on a primary screen.

In accordance with an aspect of the present invention, a method of providing an electronic program guide is provided, including: storing information of electronic program guides; displaying an electronic program guide of a channel output on a primary screen in response to a signal of outputting the information of the electronic program guides; and displaying an electronic program guide of a new channel output on the primary screen when the channel of the primary screen is changed to the new channel.

The method may further include: outputting video information corresponding to an electronic program guide of another channel when a channel of the electronic program guide is changed to the other channel.

When a signal of releasing a simultaneous change of the channel of the primary screen and a channel of the electronic program guide is input, the channel of the primary screen and the channel of the electronic program guide may be individually changed.

The method may further include: displaying an electronic program guide corresponding to a selected date in response to a signal of changing a date of the electronic program guide.

The method may further include: outputting text information or video information relating to a program title of the electronic program guide on a secondary screen output section of the electronic program guide in response to a signal of outputting the text information or the video information.

The method may further include: outputting text information or video information relating to a program title of the electronic program guide on a pop-up window in response to a signal of outputting the text information or the video information.

Programs for respective time frames of the electronic program guide may be displayed in a scrolling manner on a single screen if the programs cannot be displayed on the single screen.

In accordance with another aspect of the present invention, a method of providing an electronic program guide is provided, including: storing information of electronic program guides; displaying an electronic program guide of a channel output on a primary screen in response to a signal of outputting the information of the electronic program guides; and changing the channel of the primary screen independently of the electronic program guide of the channel output on the primary screen in response to a signal of changing the channel of the primary screen.

The method may further include: displaying an electronic program guide corresponding to a selected date in response to a signal of changing a date of the electronic program guide.

The method may further include: outputting text information or video information relating to a program title of the electronic program guide on a secondary screen output section of the electronic program guide in response to a signal of outputting the text information or the video information.

The method may further include: outputting text information or video information relating to a program title of the electronic program guide on a pop-up window in response to a signal of outputting the text information or the video information.

Programs for respective time frames of the electronic program guide may be displayed in a scrolling manner on a single screen if the programs cannot be displayed on the single screen.

### BRIEF DESCRIPTION OF THE DRAWINGS

The above and other features and advantages of the present invention will become apparent from the following description of exemplary embodiments given in conjunction with the accompanying drawings, in which:

FIG. 1 is a diagram of the inner configuration of a television according to one embodiment of the present invention;

FIGS. 2 to 4 illustrate examples of an electronic program guide displayed on a TV screen by a method of providing an electronic program guide according to one embodiment of the present invention; and

FIG. 5 is a flow chart of a method of providing an electronic program guide according to one embodiment of the present invention.

### DETAILED DESCRIPTION OF THE INVENTION

Exemplary embodiments of the present invention will be described in detail with reference to the accompanying drawings hereinafter.

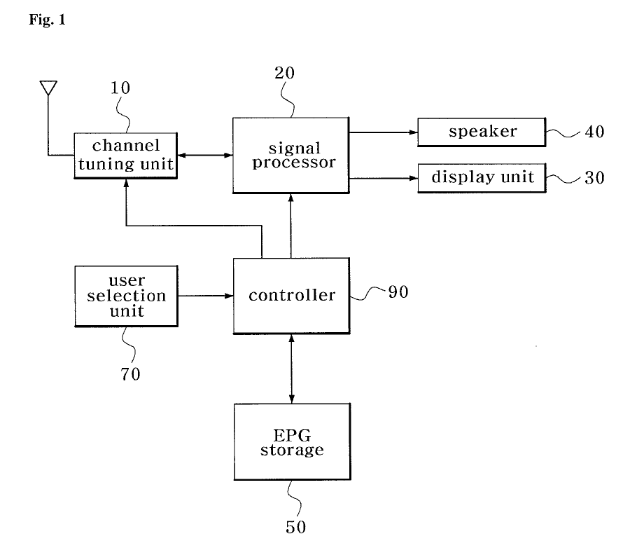

FIG. 1 is a diagram of the inner configuration of a television according to one embodiment of the present invention.

Referring to FIG. 1, the television according to one embodiment of the present invention includes a channel tuning unit 10, a signal processor 20, a display unit 30, a speaker 40, an EPG storage 50, a user selection unit 70, and a controller 90.

The channel tuning unit 10 may comprise single or plural tuners for tuning broadcasting signals, which have been received through an antenna, and a demodulator for outputting the tuned broadcasting signals in the form of a transport stream via demodulation, error correction, and the like. The channel tuning unit 10 tunes the broadcasting signals in a frequency band which corresponds to a tuning control signal from the controller 90. The channel tuning unit 10 can also receive EPG information, which is sent from respective broadcasting stations and stored in the EPG storage 50.

The signal processor 20 processes the broadcasting signals, as tuned via the channel tuning unit 10, and allows the processed broadcasting signals to be displayed on the display unit 30. The signal processor 20 processes not only the broadcasting signal received through the channel tuning unit 10, but also a video signal of a channel corresponding to the EPG information stored in the EPG storage 50, so that the video signal can also be displayed on the display unit 30.

The display unit 30 serves to output video signals, which have been decoded through the signal processor 20, among broadcasting signals of a selected channel or video signals of the channel corresponding to the EPG information stored in the EPG storage, so that the user can watch the processed video signals. The display unit 30 can be applied to a variety of display modules such as digital light processing (DLP) displays, light crystal displays (LCDs), plasma display panels (PDPs), etc.

The speaker 40 serves to output audio signals, which have been decoded through the signal processor 20, among the broadcasting signals of the selected channel, so that the user can listen to the processed audio signals.

The EPG storage 50 serves to store at least one piece of EPG information sent from at least one broadcasting station and received through the channel tuning unit 10.

The user selection unit 70 includes an EPG selection key to output the EPG information, which has been stored in the EPG storage 50, on a screen of the display unit 30. The user selection unit 70 may be provided to a main panel of the television or may be provide as a wireless remote controller. In the case where the user selection unit 70 is provide as the wireless remote controller, wireless communication apparatuses are further provided to the television and the user selection unit 70 including the EPG selection key to perform communication between the user selection unit 70 and the controller of the television.

The controller 90 includes a CPU or a microprocessor to output a variety of videos on the screen of the display unit 30 by controlling respective components.

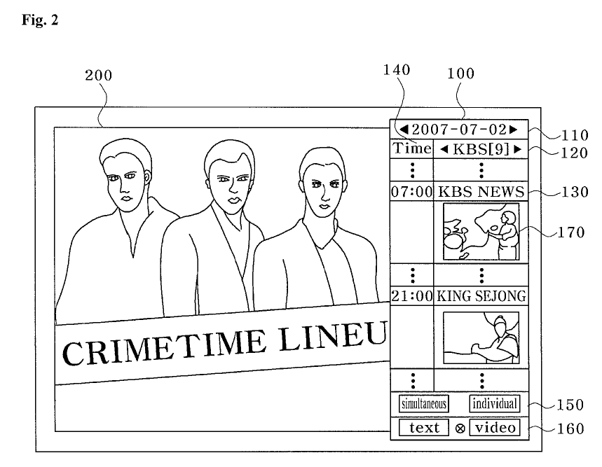

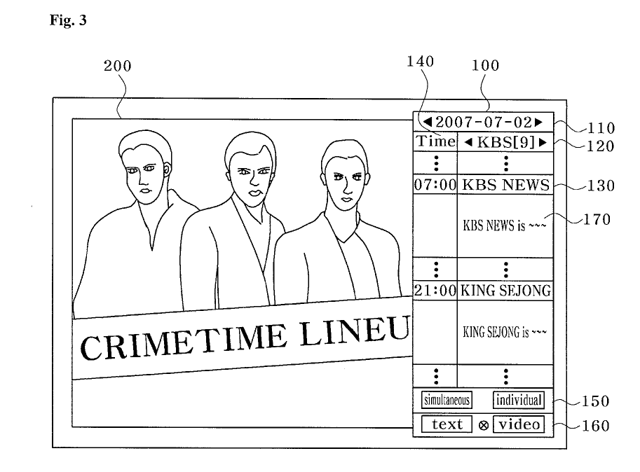

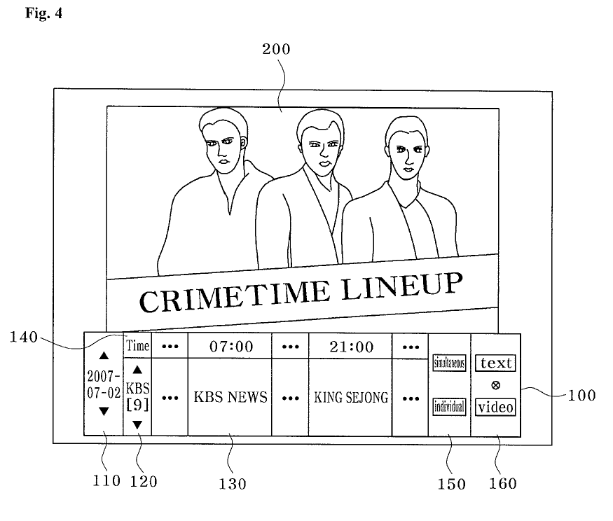

FIGS. 2 to 4 illustrate examples of an electronic program guide displayed on a TV screen by a method of providing an electronic program guide according to one embodiment of the present invention. Specifically, FIG. 2 illustrates an example of an electronic program guide displayed on the TV screen, on which contents of programs are shown in the form of videos together with broadcasting times and titles of broadcast programs in the electronic program guide. FIG. 3 illustrates another example of the electronic program guide displayed on the TV screen, in which contents of programs, such as summary of the programs, news information, previews of the programs, etc. are shown in the form of text together with the broadcasting times and titles of the broadcast programs in the electronic program guide. FIG. 4 illustrates a third example of the electronic program guide displayed on the TV screen, on which only the broadcasting times and titles of the broadcast programs are displayed in the electronic program guide.

When an EPG 100 is displayed on a TV screen by the method according to the embodiment, it can be displayed vertically on the screen as shown in FIGS. 2 and 3, or can be displayed horizontally on the screen as shown in FIG. 4.

Referring to FIG. 2, the EPG 100 may include a date selection section 110, a channel selection section 120, a program title output section 130, a broadcasting time output section 140, a synchronous selection section 150, a secondary screen selection section 160, and a secondary screen output section 170.

The date selection section 110 is a menu for allowing the user to select a date in the EPG 100. The user can inspect the EPG 100 on a desired date by positioning a cursor on the date selection section 110 using a button of the user selection unit 70 and pushing the button. That is, when EPG information is set in a unit of a week or in a unit of a month in the EPG storage 50, the user can confirm the EPG information on the desired date by means of the date selection section 110.

The channel selection section 120 is a menu for allowing the user to select a channel displayed on the EPG 100. The user can select a desired channel in the same manner as that of selecting the date on the date selection section 110. According to the present invention, since only information of a single channel is displayed on a single EPG screen as shown in the figures, the user can inspect the EPG 100 of another channel using the channel selection section 120.

The program title output section 130 serves to output titles of broadcast programs.

The broadcasting time output section 140 serves to output broadcasting times of the broadcast programs, and is generated in association with the program title output section 130. Here, if the broadcasting time output section 140 cannot be displayed on a single screen, the user can manipulate the TV screen such that the broadcasting times can be displaying in a scrolling manner.

The synchronous selection section 150 allows the user to simultaneously or individually change a channel displayed on the primary screen 200 and a channel displayed on the EPG 100 through the channel selection section 120. Thus, the user can select a simultaneous menu or an individual menu provided to the synchronous selection section 150 by means of the user selection section 70.

The secondary screen selection section 160 serves to output text information or video information relating to the programs on the secondary screen output section 170, which is disposed under the program title output section 130. Thus, the user can select a text menu or a video menu displayed on the secondary screen output section 170. When the text menu is selected, the text information as to the programs, such as program summaries, news information, program previews, etc., can be output on the secondary screen output section 170 as shown in FIG. 3. Further, when the video menu is selected, the video information as to the programs, such as summary of the programs, news information, previews of the programs, etc., can be output on the secondary screen output section 170 as shown in FIG. 2. However, when the user does not wish to inspect the text or the video through the secondary screen output section 170, the user can select a non-display menu as indicated by “\textcircled{x}” in the secondary screen selection section 160. When the non-display menu is selected, the secondary screen output section 170 is not activated at the right side of the program title output section 130 as shown in FIG. 4.

Further, according to the present invention, even when the user selects the program title output section 130 using a button of the user selection section 70, the television is permitted to output detailed information on the selected program through a pop-up window.

As described above, when the user requests EPG information, the method according to the present invention fundamentally provides only the EPG information of the same channel as that of the primary screen 200, while allowing the user to change the channel, the broadcasting date, etc.

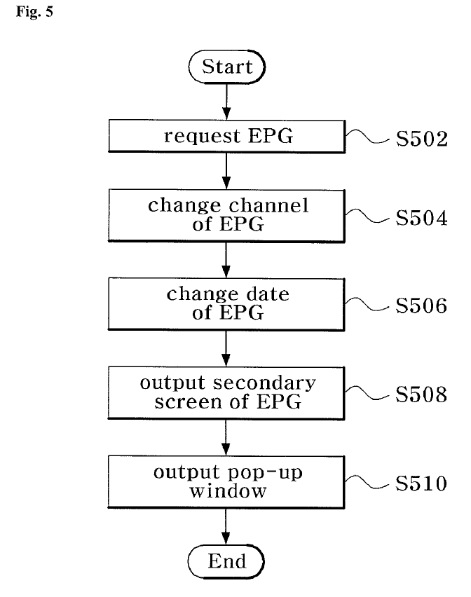

FIG. 5 is a flow chart of a method of providing an electronic program guide according to one embodiment of the present invention. Here, it should be noted that FIG. 5 is given for the purpose of illustrating a variety of methods according to the present invention and does not limit the scope of the present invention.

First, when the user requests display of EPG information using an EPG selection key on the user selection section 70, the controller 90 confirms a current channel output on the primary screen 200, extracts EPG information of the same channel as the current channel of the primary screen 200 from the EPG storage 50, and then allows the screen of the display unit 30 to display the extracted EPG information, in S502. Since EPG information is individually sent from broadcasting stations, i.e. channels, selected by the user and stored in the EPG storage 50, when EPG information of a certain broadcasting station, i.e. a certain channel, which has not been selected for a predetermined period of time by the user, is requested, the controller 90 may allow display of EPG information of other channels including the requested channel.

While reading the EPG information, the user may change a channel of an EPG 100 in S504. In other words, the user can inspect the EPG 100 relating to a desired channel by means of the channel selection section 120. Meanwhile, the user may simultaneously or individually select the channel of the primary screen 200 and the channel of the EPG 100 by selecting the simultaneous menu or the individual menu on the synchronous selection section 150.

While reading the EPG information, the user may change a date of the EPG 100 in S506. In other words, the EPG 100 generally supplies EPG information corresponding to the current date, but, when the EPG information is stored in a unit of a week or in a unit of a month, the user may select a desired date through the date selection section 110 to confirm the EPG 100 corresponding to the desired date.

The user may confirm the titles of broadcast programs through the program title output section 130. Alternatively, the user can inspect text information or video information relating to the programs through the secondary screen output section 170 by selecting a text menu or a video menu on the secondary screen output section 170 in S508.

Further, even when only the titles of the programs are output due to inactivation of the secondary screen output section 170 (see FIG. 4), the user can inspect the text information or the video information relating to the programs through a pop-up window, which is activated by selection of the program title output section 130, in S5 10. The user can select a preset menu for activating the pop-up window. Further, the user can set a menu to output one of the text information and the video information through the pop-up window.

As apparent from the above description, the method according to the present invention permits output of an electronic program guide relating to the same channel as a current channel displayed on a primary screen while allowing the user to directly change the channel of the EPG, thereby improving user convenience.

Further, the method according to the present invention can supply program information together with text information or video information relating to the program information, so that much more information can be more easily supplied to the user.

Although the present invention has been described with reference to the embodiments and the accompanying drawings, it will be apparent to those skilled in the art that the embodiments are given by way of illustration, and that various modifications and equivalent embodiments can be made without departing from the spirit and scope of the present invention. Further, although the method of providing an electronic program guide has been described as being applied to a television, the method of the present invention can be applied to other displays as well as the television. Accordingly, the scope of the present invention should be limited only by the accompanying claims.

What is claimed is:

1. A method of providing an electronic program guide, comprising:
storing information of electronic program guides;
displaying an electronic program guide of a channel output on a primary screen in response to a signal of outputting the information of the electronic program guides; and
displaying an electronic program guide of a new channel output on the primary screen when the channel of the primary screen is changed to the new channel.

2. The method according to claim 1, further comprising:
outputting video information corresponding to an electronic program guide of another channel when a channel of the electronic program guide is changed to the other channel.

3. The method according to claim 1, wherein, when a signal of releasing a simultaneous change of the channel of the primary screen and a channel of the electronic program guide is input, the channel of the primary screen and the channel of the electronic program guide are individually changed.

4. The method according to claim 1, further comprising:
displaying an electronic program guide corresponding to a selected date in response to a signal of changing a date of the electronic program guide.

5. The method according to claim 1, further comprising:
outputting text information or video information relating to a program title of the electronic program guide on a secondary screen output section of the electronic program guide in response to a signal of outputting the text information or the video information.

6. The method according to claim 1, further comprising:
outputting text information or video information relating to a program title of the electronic program guide on a pop-up window in response to a signal of outputting the text information or the video information.

7. The method according to claim 1, wherein programs for respective time frames of the electronic program guide are displayed in a scrolling manner on a single screen if the programs cannot be displayed on the single screen.

8. A method of providing an electronic program guide, comprising:
storing information of electronic program guides;
displaying an electronic program guide of a channel output on a primary screen in response to a signal of outputting the information of the electronic program guides; and
changing the channel of the primary screen independently of the electronic program guide of the channel output on the primary screen in response to a signal of changing the channel of the primary screen.

9. The method according to claim 8, further comprising:
displaying an electronic program guide corresponding to a selected date in response to a signal of changing a date of the electronic program guide.

10. The method according to claim 8, further comprising:
outputting text information or video information relating to a program title of the electronic program guide on a secondary screen output section of the electronic program guide in response to a signal of outputting the text information or the video information.

11. The method according to claim 8, further comprising:
outputting text information or video information relating to a program title of the electronic program guide on a pop-up window in response to a signal of outputting the text information or the video information.

12. The method according to claim 8, wherein programs for respective time frames of the electronic program guide are displayed in a scrolling manner on a single screen if the programs cannot be displayed on the single screen.
